(19) United States
(12) Patent Application Publication
(10) Pub. No.: US 2009/0177994 A1
(43) Pub. Date: Jul. 9, 2009

(54) DOUBLE SCROLLING

(75) Inventors: Gerrit Hollemans, Eindhoven (NL); Vincentius Paulus Buil, Eindhoven (NL); Marco Van Leeuwen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,899

(22) PCT Filed: Jan. 4, 2005
(86) PCT No.: PCT/IB05/50022

§ 371 Date: Jun. 28, 2006

(30) Foreign Application Priority Data
Jan. 9, 2004 (EP) 04100048.0

(51) Int. Cl. G06F 3/048

(52) U.S. Cl. 715/784

(57) ABSTRACT

A method of providing screen scrolling in content, such as hierarchically ordered content, is provided, wherein at least one level in the content comprises a page level comprising pages of objects and an object level comprising the objects, the method comprises the steps of: scrolling the objects page-by-page in the page level, and scrolling the objects object-by-object in the object level. Especially when scrolling in larger amounts of content, such as hierarchically ordered content, it is an advantage of interweaving a page by page level with an object by object level, so that the user may choose a specific level to navigate either page-wise or object-wise.

### FIELD OF INVENTION

The present invention relates to a method and a graphical user interface for navigating in data and more specifically to a method and a graphical user interface for navigating in the data with the use of a limited number of key or mouse operations.

### BACKGROUND OF THE INVENTION

Navigation in hierarchically arranged data may be cumbersome and many key or mouse operations are often necessary to find a specific object. Especially when more content need to be displayed than fits a single screen, the user need to apply multiple key strokes and/or mouse operations to access the content that is available but not visible.

When the content that needs to be displayed can be considered a list of items, an up/down operation can be supported such that when the last visible item on the screen is reached, part of the screen is refreshed to display previously invisible items of the list.

This navigation per item is sufficient as long as the list of item to be scrolled is not large. Typically when several screens can be filled with the items of the list a screen-by-screen scrolling operation is offered to the user. This operation is usually offered through a set of extra keys (PgUp, PgDn) or mouse operations (move and click on scroll bar).

However, this method has two disadvantages: extra keys are needed and the flow of the navigation from top of the hierarchy (all content) to the bottom (single item) is disrupted.

### SUMMARY OF THE INVENTION

It is an object of the present invention to allow for easy navigation in content, such as data.

According to the above and other aspects of the invention, a method of providing screen scrolling in content is provided, wherein at least one level in the content comprises a page level comprising pages of objects and an object level comprising the objects, the method comprises the steps of
scrolling the objects page-by-page in the page level, and
scrolling the objects object-by-object in the object level.

Especially when scrolling in larger amounts of content, it is an advantage of interweaving a page by page level with an object by object level, so that the user may choose a specific level to navigate either page-wise or object-wise.

This feature makes the navigation simpler in that only one key is necessary for scrolling and, furthermore, the flow of the navigation is smoother and not disrupted at page shifts. This is especially advantageous when the number of objects is large or when the window or panel in which the objects are to be displayed is small, so that only a limited number of objects, such as 10, 5 or 3 objects, such as 1-10 objects, are simultaneous visible in a window or panel.

Furthermore, when navigating in content on e.g. a television screen using non-dedicated scrolling means, e.g. a remote control, as scrolling control device, it is advantageous to introduce as few scrolling elements or keys for the user as possible.

The objects may comprise items or containers, the containers may then further comprise items and/or containers.

The content may be ordered or structured in any way. The content may be a web of pages, it may be hierarchically ordered content, etc. Preferably, the content is ordered so that the selections in one panel determines what is possible beyond that point.

When moving through a hierarchy, any directory or sub-directory comprising objects, such as items or containers, may thus comprise a first level list and the objects comprised in e.g. containers of the first level list will then be referred to as second level objects.

The content may be any content, such as data, such as word processing documents, spreadsheets, databases, any multimedia information, such as music or video content, such as an internet or television content, etc.

Preferably, the at least one level in the hierarchy comprises a predetermined number of objects, the page level comprises pages of a selected number of the predetermined number of objects, and the object level comprises the predetermined number of objects. Thus, all objects in the at least one level are provided in the object level, whereas pages of objects are provided in the page level. Alternatively, only the objects of a selected page are provided in the object level. The page level may comprise any selected number of the predetermined number of objects. Preferably, the selected number of the predetermined number of objects corresponds to the number of objects visible on a screen. However, also a selected number of objects corresponding to objects visible on half or a quarter of a screen may be chosen.

The page level scrolling and the object level scrolling may be operated similarly. Thus, the page level scrolling and the object level scrolling may be operated by same scrolling means or same scroll control devices. The scrolling of objects in a list may thus be performed by any means, such as by any scroll control device, such as by keystrokes, such as by mouse operations, etc. For example, in a preferred embodiment, the same scrolling means are up/down arrows.

Hereby, the user need to apply only one kind of key strokes and/or mouse operations to access content that is available but not visible. It is an advantage of being able to use only a single scrolling means, and furthermore, the separated but interwoven navigation allows for improved control of the scrolling.

A first level of the content, such as for example a first level of hierarchically ordered content, may comprise a number of first level objects and at least one of these first level objects may comprise a page level and/or an object level.

Preferably, the first level list is shown in a first panel and the page level and the object level is shown in a second panel of a screen. The page level and the object level may both be displayed at the same time, so that only the scroll function is changed on changing between page level and object level. Hereby, pages of objects are displayed upon page scrolling. The page level may be represented by e.g. a scroll bar. Alternatively, only one level is shown at a time, so that either the page level or the object level is shown. The page level may be represented by e.g. a compressed list of pages.

In a preferred embodiment scrolling of the last of the predetermined number of objects in the page level and/or object level generates a shift to a subsequent object in the first level list. Preferably, the subsequent object in the first level list is immediate subsequent to the first object in the first level list.

Scrolling through more objects than are simultaneous visible on a screen, a first page scrolling may be provided upon object by object scrolling of a last visible object of a first number of visible objects, so as to display a new number of objects now visible on the screen.

Additionally, when navigating in a list of objects, in any level of the hierarchy, where the list of objects comprise more objects than what can be shown in a single screen window or panel, i.e. wherein the list of objects (items or containers) are too big to be visible on a single screen, it is preferred to shift an entire page upon scrolling of a last visible item of the list so as to display a new part of the list of objects visible in the screen window. Hereby, upon object by object scrolling of a last visible object of a first predetermined number of visible objects, a first page scrolling is provided so as to display a new predetermined number of visible objects.

The above described method may be provided in the form of a computer program product enabling a programmable device when executing said computer program product to function as a method as defined above.

According to another aspect of the present invention, a method of providing screen scrolling in content is provided, wherein the content comprises at least a first level list of objects and at least a corresponding second level list of objects, each second level list comprising a predetermined number of objects and being associated with a first level object, the method comprises
selecting a first object in the first level list,
scrolling all but the last of the predetermined number of second level objects associated with the selected first object, object by object,
scrolling the last of the predetermined number of the second level objects by shifting to a second level list of objects associated with a second object in the first level list.

The content may be hierarchically ordered content.

The objects may comprise items or containers, and in a preferred embodiment the association between the first level object and second level objects is achieved by arranging the content in directories comprising containers and corresponding subdirectories comprising items and/or containers. The containers may then further comprise items and/or containers.

Preferably, the first level list is shown in a first panel and the second level list is shown in a second panel of a screen, even more preferred the first panel is to the left of the second panel.

For example, when selecting a container in a second level list of objects displayed in the second panel, the content of the second level list will be displayed in the first panel and now be the first level list, and the content of the selected container will be shown in the second panel and now be the second level list.

When navigating in a second level list of objects associated to a first object in a first level list, navigation may be performed by the scrolling of all but the last object in the second level list, preferably object by object. Scrolling of the last object in the second level list results in a shift to a subsequent second object in the first level list, and a corresponding shift to a second level list of objects associated with the second object in the first level list. Hereby, the second level list associated with the second object in the first level list is displayed in the second panel. It is envisaged that the second level list associated with the second object of the first level list may also be displayed in an additional window or an additional panel opened or generated upon scrolling of the last object in the second level list associated with the first object in the first level list. In this case it is preferred that the additional panel or window is positioned so as not to cover the first level list or at least so as not to cover a significant part of the first level list.

Preferably, the second object is immediate subsequent to the selected first object in the first level list. Alternatively, the second object may be the subsequent object comprising a second level list, for example when the first level list comprises intermingled items and containers.

According to a further aspect of the present invention a graphical user interface for displaying content, is provided wherein the content comprises at least one page level comprising pages of objects and at least one object level comprising the objects. The page level and the object level are being interwoven so as to allow a user to shift between levels in the content hierarchy to provide page-by-page scrolling and object-by-object scrolling, respectively.

In a preferred embodiment, the content is hierarchically ordered content.

Furthermore, the graphical user interface may allow for page scrolling upon object by object scrolling of a last visible object of a first predetermined number of visible objects, so that a first page scrolling is provided to display a new predetermined number of visible objects.

A computer program product enabling a programmable device when executing said computer program product to function as a graphical user interface as described above may further be provided.

### BRIEF DESCRIPTION OF THE DRAWINGS

FIG. 1 shows how lists and pages of objects are interwoven.

FIGS. 2a and 2b show a prior art navigation, and FIGS. 2a and 2c show navigation according to the present invention.

### DETAILED DESCRIPTION OF THE DRAWINGS

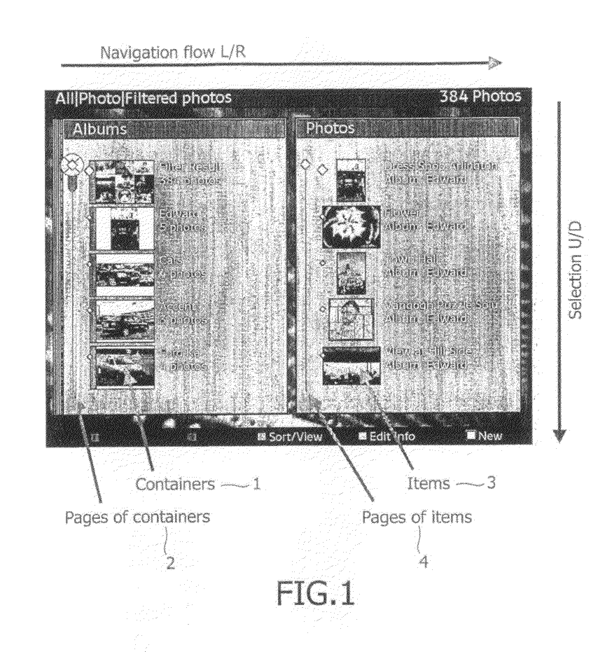

FIG. 1 shows an embodiment according to the present invention wherein list of containers 1, i.e. Albums, are interwoven with pages of containers 2, and also lists of items 3, i.e. photos, in the containers are interwoven with pages of items 4. The pages of containers 2, 4 are represented as scroll bars, in this embodiment to the left of the lists of items and/or containers (objects). The one or more scroll bars are provided to visualise the page level navigation.

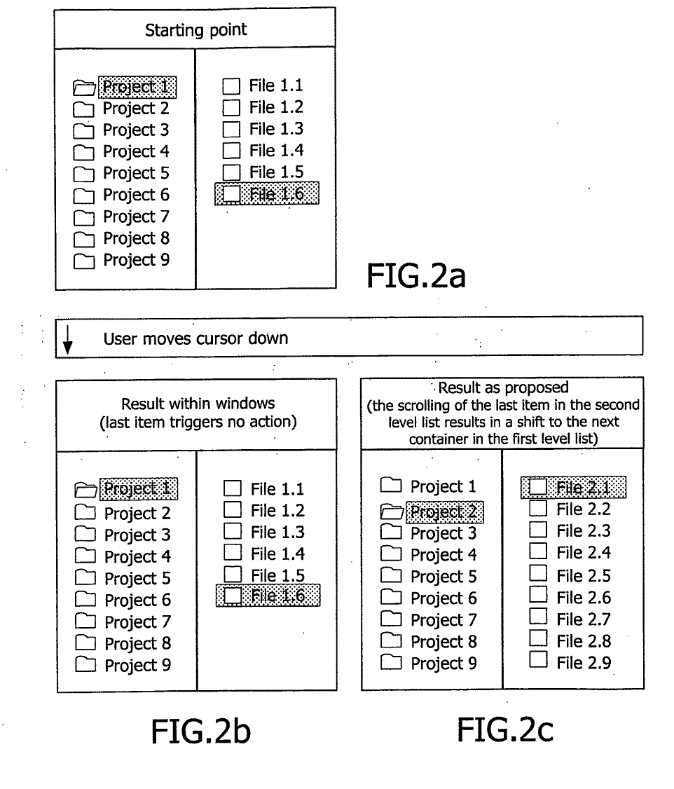

In FIG. 2a, a list of first level objects is shown in a first panel, the objects being containers or folders named Project 1 to Project 9. Project 1 is selected, and the content of the container is displayed in a second panel. The container comprises a second level list, namely Files 1.1 to 1.6. Upon selection of the last item in the second level list, File 1.6, no action is performed and the resulting window is shown in FIG. 2b, wherein File 1.6 is still selected.

According to a preferred invention of the present invention, FIG. 2a in combination with FIG. 2c show a navigation according to the present invention. Thus, it is seen that upon selection of the last item in the second level list, File 1.6, the next container, i.e. container Project 2, in the first level list is selected and the associated list of Files 2.1 to 2.9 is shown in the second panel.

1. A method of providing screen scrolling in content, wherein at least one level in the content comprises a page level comprising pages of objects and an object level comprising the objects, the method comprises the steps of
scrolling the objects page-by-page in the page level, and
scrolling the objects object-by-object in the object level.

2. A method according to claim 1, wherein the at least one level in the content comprises a predetermined number of objects, the page level comprises pages of a selected number of the predetermined number of objects, and the object level comprises the predetermined number of objects.

3. A method according to claim 2, wherein the selected number of the predetermined number of objects corresponds to the number of objects visible on a screen.

4. A method according to any of the preceding claim 1, wherein the page level scrolling and the object level scrolling are operated by same scrolling means.

5. A method according to claim 4, wherein the scrolling means are up/down arrows.

6. A method according to claim 1, wherein a first level in the content comprises a number of first level objects and at least one of these first level objects comprises a page level and/or an object level.

7. A method according to claim 6, wherein scrolling of the last of the predetermined number of objects in the page level and/or object level generates a shift to a subsequent object in the first level list.

8. A method according to claim 7, wherein the subsequent object in the first level list is immediate subsequent to the first object in the first level list.

9. A method according to claim 1, wherein upon object by object scrolling of a last visible object of a first number of visible objects, a first page scrolling is provided so as to display a new number of visible objects.

10. A method according to claim 1, wherein the content is hierarchically ordered content.

11. A computer program product enabling a programmable device when executing said computer program product to function as a method as defined in claim 1.

12. A graphical user interface for displaying content, wherein the content comprises at least one page level comprising pages of objects and at least one object level comprising the objects, the page level and the object level being interwoven so as to allow a user to shift between levels in the content to provide page-by-page scrolling and object-by-object scrolling, respectively.

13. (canceled)

14. A method of providing screen scrolling in content, wherein the content comprises a first level list of objects and corresponding second level lists of objects (items or containers), each second level list comprising a predetermined number of objects and being associated with a first level object, the method comprises
selecting a first object in the first level list,
scrolling all but the last of the predetermined number of second level objects associated with the selected first object, object by object,
scrolling the last of the predetermined number of the second level objects by shifting to a second level list of objects associated with a second object in the first level list.
